(19) United States
(12) Patent Application Publication
(10) Pub. No.: US 2003/0177204 A1
(43) Pub. Date: Sep. 18, 2003

(54) System and method for installing a web-based imaging device outside a firewall

(76) Inventors: Darrel Cherry, Boise, ID (US); James Clough, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/100,937

(22) Filed: Mar. 18, 2002

(51) Int. Cl. G06F 15/16

(52) U.S. Cl. 709/219

(57) ABSTRACT

A method of installing a Web-based imaging device for printing from a client computer located on a private network, where the Web-based imaging device is isolated from the private network by a firewall, but may be physically located near the client computer. The Web-based imaging device may be installed using information from a Web site on an external network. The external network may be a public network such as the Internet. The invention also includes a system having a Web-based imaging device outside a firewall and configurable by information from a Web site on an external network, a Web-based imaging device including a method of installation and a computer storage media including computer instruction implementing the method of installing such a Web-based imaging device.

### FIELD OF THE INVENTION

The present invention relates generally to image processing systems. More particularly, the present invention relates to a system and method for installing a Web-based imaging device for use by a client computer on a private network, where the imaging device is physically located outside of a firewall relative to the private network and configurable by information from a Web page located on an external network.

### BACKGROUND OF THE INVENTION

Imaging devices, e.g, printers, facsimile machines and copiers, are commonly used to print documents. Such imaging devices may be configured for standalone operation with a single computer. However, since imaging devices may be very expensive, it is often preferable to be able to share such devices between multiple users on a computer network. Networked imaging devices are common today.

Computer networks may be as simple as a few personal computers linked together in a single building in a local area network (LAN). Alternatively, multiple geographically distinct sites within large organizations may be linked together using a wide area network (WAN). Among the largest of the networks is the public Internet. As the Internet provides a valuable resource for information and communication, many LANs and WANs are also connected to the Internet.

Concerns over the security of being connected to the Internet and safeguarding sensitive information from hackers, has led to the development of security measures such as firewalls. A firewall is a system designed to prevent unauthorized access to or from a private network. Firewalls can be implemented in both hardware and software, or a combination of both. There are various types of firewall techniques known to one of ordinary skill in the art, e.g., packet filter, application gateway, circuit-level gateway and proxy server.

Configuring a computer for printing to a networked printer is not a simple task for the computer illiterate. Even for the experienced computer user, configuring a printer requires a number of steps within a given operating system and usually requires some knowledge about the printer being configured. Configuring a computer to print from a networked printer frequently requires the assistance of a network administrator or someone else with the requisite computer skills.

For example, if a user of a networked client computer running Microsoft® Windows98™ operating system wants to install a networked Hewlett-Packard®, Color LaserJet™, model 4500 PCL 5c, for printing from the client computer, the user typically must perform the following fourteen steps: (1) select or click on the “Start” button, (2) mouse over the “Settings” tab, (3) select or click on the “Printers” tab, (4) select or double-click on the “Add Printer” icon, (5) select or click on the “Next” button on the “Add Printer Wizard” window that pops up, (6) select the “Network printer” radio dial from the options of “Local printer” and “Network printer, (7) select or click on the “Next” button, (8) type the network path or the queue name of your printer and if you don't know the name of your printer click the “Browse” button to view available network printers and select from among the pseudo-named available printers from the tree structure in the “Network Neighborhood,” (9) click on the “Next” button, (10) select “HP” from the “Manufacturers” window and select “Color LaserJet 4500” from the “Printers” window or alternatively click on the “Have disk . . . ” button and select the desired printer from disk media, (11) click on the “Next” button, (12) select whether to make the selected printer a “default” printer for software applications, (13) click on the “Next” button, and (14) click on the “Finish” button.

The above printer installation steps may fail when attempting to install a printer outside a firewall or virtual private network (VPN). Other operating systems may require more or fewer steps than those illustrated above to install a printer. For many private networks, it is preferable, for security reasons, to have all client computers and peripherals within the private network behind a firewall. The region outside of a private network protected by a firewall is occasionally referred to in the art as a demilitarized zone, or DMZ. Firewalls may prevent users in the DMZ from printing to a printer located on the private network that is protected by the firewall.

For the above reason, it may be advantageous to have a Web-based printer located topologically outside of a firewall. A Web-based printer located outside of a firewall may be used by users in the DMZ who wish to print to a printer physically located near or within the same structure as a private network. However, the Web-based printer is typically an asset belonging to, and supported by, the owner of the private network. Additionally, users within the private network may wish to print to the Web-based printer, because it may be the nearest printer. This still leaves the problem of installing such a Web-based printer outside a firewall for printing from within the firewall protected private network.

For all of the above reasons there exists a need in the art for a method of installing an imaging device for use by a user on a client computer located within a firewall protected private network, where the installation procedure is simpler than conventional methods of installation, that allows the installation to take place from anywhere including behind multiple firewalls and that does not require the user to know information about the printer being installed.

### SUMMARY OF THE INVENTION

The present invention includes a method of installing a Web-based imaging device for printing from a client computer located on a private network, where the Web-based imaging device is isolated from the private network by a firewall, but may be physically located near the client computer. The present invention also includes a system having a Web-based imaging device outside a firewall and configurable by information from a Web site on an external network.

A method of the present invention for installing a Web-based imaging device for use by a client computer on a private network isolated by a firewall, where the Web-based imaging device is located outside the firewall, may include browsing to a Web page including information for installing the Web-based imaging device. The method of the present invention may further include downloading the information to the client computer and installing the Web-based imaging device on the client computer for use by the client computer.

A computer system of the present invention may include a private network having a plurality of client computers in communication with each other over the private network and a firewall in communication with the private network and isolating the private network from external networks. The computer system may also include a Web-based imaging device outside of the firewall and configurable for use by any of the client computers and configurable from any of the client computers.

A computer storage media including computer instructions implementing a method of installing a Web-based imaging device for use by a client computer on a private network isolated by a firewall, wherein the Web-based imaging device is located outside the firewall is also disclosed. Additionally, a Web-based imaging device configurable for use by a client computer on a private network isolated by a firewall, wherein the Web-based imaging device is located outside the firewall and includes computer instructions for implementing a method of installing the Web-based imaging device is disclosed.

These above method and system of the present invention will be readily understood by reading the following detailed description taken in conjunction with the drawings.

### DESCRIPTION OF THE DRAWINGS

FIG. 1 is a flow chart of a method for Web-based installation of a Web-based imaging device in accordance with the present invention.

FIG. 2 is a block diagram of a system in accordance with the present invention.

### DETAILED DESCRIPTION OF THE INVENTION

The present invention includes a method of installing a Web-based imaging device for use by a client computer located on a private network, where the Web-based imaging device is isolated from the private network by a firewall, but may be physically located near the client computer. The Web-based imaging device may be installed using information from a Web site on an external network. The external network may be a public network such as the Internet. The present invention also includes a system having an internal network protected by a firewall, at least one Web-based imaging device outside the firewall and configurable by information from a Web site on an external network. For convenience only, a printer will be used as the exemplary imaging device described herein. However, one of skill in the art will recognize that the inventive methods and systems described herein are also applicable to copy machines, facsimile machines and other imaging devices, not just printers.

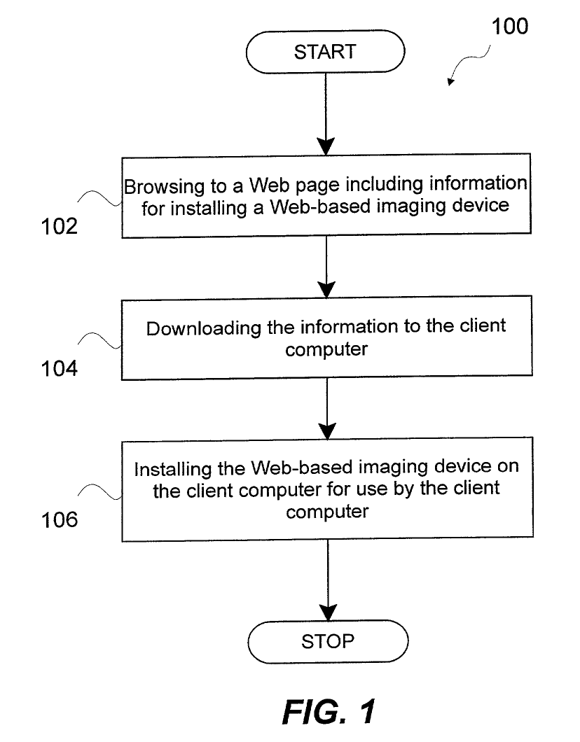

FIG. 1 is a flow chart of a method 100 for Web-based installation of a printer in accordance with the present invention. Method 100 includes browsing 102 from a client computer on a private network to a Web page that supports a printer or set of printers. Method 100 further includes downloading 104 information from the Web page. The information may include all necessary information for configuring a client computer to print to the printer or set of printers. The Web page may be located on any Web server computer located on any external network. An external network may be another private network, a LAN, a WAN, or a public network, i.e., the Internet. Method 100 further includes executing 106 the downloaded executable program and, thereby, installing a remote printing port monitor, printer, and printer driver for the specified printer or set of printers on a client computer.

Method 100 allows a user at a client computer located on a private network isolated from external networks by a firewall to set up and use a printer that is physically located near the user's client computer and yet outside the firewall. The printer may even be topologically behind yet another firewall. Method 100 allows any user to simply browse to a Web site that has one or more links for the user to click on and thereby download and install the necessary print system files on the user's client computer. Method 100 avoids the prior art method of installing a printer requiring multiple steps and knowledge about the model of printer being installed.

Downloading 104 information from the Web page may be accomplished in a number of ways in accordance with the present invention. The Web page may present a hyperlink for the user to click on to download the information to the client computer. The Web page may deliver the information necessary to install an imaging device using any one of a number of techniques, for example and not by way of limitation, cookies, modified executable programs, or ActiveX control. An ActiveX control, for instance, may be automatically downloaded and executed by a Web browser. ActiveX control is not a programming language, but rather a set of rules for how applications should share information. A programmer of ordinary skill in the art may develop ActiveX controls in a variety of languages, including, for example and not by way of limitation, C, C++, Visual Basic and Java. As one of ordinary skill in the art will know how to implement these various methods of information delivery, they will not be further detailed herein.

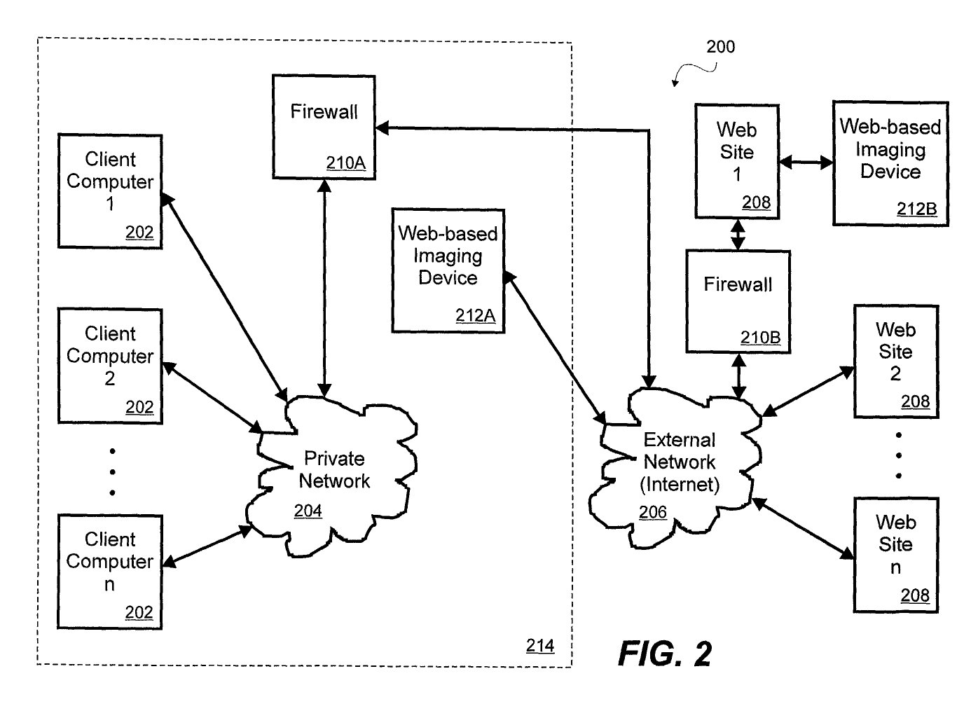

FIG. 2 is a block diagram of a system 200 in accordance with the present invention. System 200 includes a plurality of client computers 202 (three are shown) in communication with a private network 204. System 200 also includes an external network 206 in communication with multiple web sites 208 (three are shown). The external network 206 may be another private network, a LAN, a WAN, or a public network, i.e., the Internet. The external network 206 is also in communication with the private network 204 through at least one firewall 210A. System 200 also includes at least one Web-based imaging device 212A and 212B (two are shown). The private network 204, client computers 202, firewall 210A and imaging device 212A may be co-located in a single structure 214, such as an office building. Client computers 202, private network 204 and firewall 210A, may comprise a VPN.

A Web-based imaging device 212A and 212B may be located virtually anywhere in system 200. For example and not by way of limitation, Web-based imaging device 212A may be in direct communication with external network 206. Web-based imaging device 212B may be in communication with a Web site 208, which is in turn in is isolated from external network by another firewall 210B. Method 100 allows a user at a client computer 202 to configure and print to either Web-based imaging device 212A or 212B. Method 100 even allows a user at a client computer 208 to configure and print to Web-based imaging device 212B from within a VPN inside of building 214 through both firewalls 210A and 210B.

The method 100 of the present invention may be implemented as computer instructions configured for execution by a processor. Such computer instructions may be stored on computer storage media. Exemplary computer storage media may include, for example and not by way of limitation, a compact disc (CD), floppy disk, removable hard disk, Zip™ Disk, digital versatile disk (DVD), or any other suitable computer storage media. Furthermore, method 100 for Web-based installation of a printer may be included in, and executable from, a Web-based imaging device for which the method 100 applies. For example, method 100 may be implemented in computer instructions stored on a nonvolatile memory device in the Web-based imaging device. The nonvolatile memory device may be, for example and not by way of limitation, a read only memory (ROM), a programmable ROM (PROM), an electrically programmable ROM (EPROM), and electrically erasable PROM, (EEPROM), Flash memory, or any other suitable nonvolatile memory device.

One advantage of the present invention is that it allows a user to configure a printer outside a firewall for printing. An additional advantage of the present invention is that the user need not know anything about the printer outside the firewall in order to configure it for printing from a client computer inside the firewall. The user simply browses to a Web site that knows which printer or printers the user will need to print to. Since the Web site knows this information, it passes the necessary configuration data to the client computer and prompts the user to download the installation file. The installation process may be reduced to a minimum number of steps.

The present invention potentially saves time and network resources for installation of Web-based imaging devices, such as a printer. The present invention solves the problem of complex printer setups for computer users. The present invention may also provide an ad-hoc printing capability. Furthermore, the present invention solves the problem of complex support for a company that provides a printing service for its customers. While the method 100 for Web-based installation of an imaging device described herein allows a user to install a printer from within a private network protected by a firewall, the invention may also allow anyone on the network to install the printer, including users on a external network.

Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A method of installing a Web-based imaging device for use by a client computer on a private network isolated by a firewall, said Web-based imaging device located outside said firewall, said method comprising:
browsing to a Web page including information for installing said Web-based imaging device;
downloading said information to said client computer; and
installing said Web-based imaging device on said client computer for use by said client computer.

2. The method of claim 1, wherein said Web page includes a Web page located on an external network.

3. The method of claim 2, wherein said external network comprises a public Internet.

4. The method of claim 1, wherein said information comprises at least one of an executable program and ActiveX control.

5. The method of claim 1, wherein said downloading comprises clicking on a hyperlink.

6. The method of claim 1, wherein said Web-based imaging device comprises a printer.

7. The method of claim 1, wherein downloading comprises obtaining information from a Web site isolated from said client computer by a firewall and a virtual private network including another firewall.

8. A computer system, comprising:
a private network having a plurality of client computers in communication with each other over said private network;
a firewall in communication with said private network and isolating said private network from an external network and configured to allow said plurality of client computers to communicate with a Web site located on said external network; and
a Web-based imaging device outside of said firewall and configurable for use by, and from any, of said plurality of client computers.

9. The computer system of claim 8, wherein said Web-based imaging device comprises at least one of a printer, a copy machine, a facsimile machine, and a combination of a printer, a copy machine and a facsimile machine.

10. The computer system of claim 8, further comprising an external network in communication with said private network through said firewall.

11. The computer system of claim 10, further comprising at least one Web site in communication with said external network and including information necessary for configuring said Web-based imaging device for use by any of said plurality of client computers.

12. The computer system of claim 11, wherein said information comprises at least one of a modified executable program and ActiveX control.

13. The computer system of claim 8, further comprising a virtual private network isolating said Web-based imaging device from said plurality of client computers.

14. The computer system of claim 13, wherein said firewall includes said virtual private network.

15. A computer system, comprising:
a private network having at least two client computers in communication with each other over said private network;
a first firewall in communication with said private network and isolating said private network from external networks;
an external network in communication with said private network through said first firewall;
a Web-based imaging device configurable for use by any of said at least two client computers and configurable from any of said at least two client computers;
a Web site in communication with said Web-based imaging device and including information for configuring said Web-based imaging device for printing from any of said at least two client computers; and
a second firewall isolating said Web site from said Web-based imaging device.

16. The computer system of claim 15, wherein said Web-based imaging device comprises at least one of a printer, a copy machine, a facsimile machine, and a combination of a printer, a copy machine and a facsimile machine.

17. The computer system of claim 15, wherein said information comprises at least one of a modified executable program and an ActiveX control.

18. The computer system of claim 15, wherein said Web-based imaging device is configurable from a computer on an external network isolated from said private network by said first firewall.

19. The computer system of claim 15, wherein said first firewall includes a virtual private network.

20. The computer system of claim 15, wherein configuring said Web-based imaging device for printing comprises clicking on a hyperlink with a browser viewing said Web site from one of said at least two client computers.

21. A computer storage media including computer instructions for implementing a method of installing a Web-based imaging device for use by a client computer on a private network isolated by a firewall, said Web-based imaging device located outside said firewall, said method comprising:
browsing to a Web page including information for installing said Web-based imaging device;
downloading said information to said client computer; and
installing said Web-based imaging device on said client computer for use by said client computer.

22. The computer storage media of claim 21, wherein said Web page includes a Web page located on an external network.

23. The computer storage media of claim 22, wherein said external network comprises a public Internet.

24. The computer storage media of claim 21, wherein said information comprises at least one of an executable program and ActiveX control.

25. The computer storage media of claim 21, wherein said downloading comprises clicking on a hyperlink.

26. The computer storage media of claim 21, wherein said Web-based imaging device comprises a printer.

27. The computer storage media of claim 21, wherein downloading comprises obtaining information from a Web site isolated from said client computer by a firewall and a virtual private network including another firewall.

28. The computer storage media of claim 21, further comprising a compact disc.

29. A Web-based imaging device configurable for use by a client computer on a private network isolated by a firewall, said Web-based imaging device located outside said firewall and including computer instructions for implementing a method of installing said Web-based imaging device, said method comprising:
browsing to a Web page including information for installing said Web-based imaging device;
downloading said information to said client computer; and
installing said Web-based imaging device on said client computer for use by said client computer.

30. The Web-based imaging device of claim 29, wherein said Web page includes a Web page located on an external network.

31. The Web-based imaging device of claim 30, wherein said external network comprises a public Internet.

32. The Web-based imaging device of claim 29, wherein said information comprises at least one of an executable program and ActiveX control.

33. The Web-based imaging device of claim 29, wherein said downloading comprises clicking on a hyperlink.

34. The Web-based imaging device of claim 29, wherein said Web-based imaging device comprises a printer.

35. The Web-based imaging device of claim 29, wherein downloading comprises obtaining information from a Web site isolated from said client computer by a firewall and a virtual private network including another firewall.

36. The Web-based imaging device of claim 29, further comprising firmware for storing said computer instructions for implementing said method of installing said Web-based imaging device.
